(19) United States
(12) Patent Application Publication
(10) Pub. No.: US 2013/0317945 A1
(43) Pub. Date: Nov. 28, 2013

(54) BROWSER BASED MAPPING REGION BUILDER

(71) Applicants: Jeffrey Gerard Doleweerd, Orillia (CA); Timothy Ryan Berezny, Barrie (CA)

(72) Inventors: Jeffrey Gerard Doleweerd, Orillia (CA); Timothy Ryan Berezny, Barrie (CA)

(73) Assignee: Doleweerd Consulting Inc., Orillia, ON (CA)

(21) Appl. No.: 13/983,899

(22) PCT Filed: Feb. 3, 2012
(86) PCT No.: PCT/CA2012/000103

§ 371 Date: Aug. 6, 2013

(30) Foreign Application Priority Data
Feb. 18, 2011 (CA) 2,732,301

(51) Int. Cl. G06Q 30/06

(52) U.S. Cl. CPC G06Q 30/0623
USPC 705/26.61

(57) ABSTRACT

The present invention is a computer-based region building system for allowing a service provider to build a service region using a web browser interface. The system presents predefined service areas to the service provider which the service provider can choose to add to the current service region and thereby build a service region. The system maintains a database of service regions and service provider information and allows a consumer to search the database to find service providers that service the consumer's region.

### FIELD OF THE INVENTION

The present invention relates to systems for mapping service regions and more particularly to web-based systems for specifying service regions and identifying service providers.

### BACKGROUND OF THE INVENTION

There are many existing websites that allow consumers to search for service providers. A consumer typically enters an address and some indication of the type of service desired, and then the website presents the consumer with a list of possible service providers, which may be presented in the form of markers on a map or in a list. The methods for such websites to identify candidate service providers are generally held as trade secrets and not known to the public. In some cases, the website may simply maintain a database of potential providers with their office or store locations and inform a consumer who searches for a service provider of which service providers in the website's database are closest to the location specified by the consumer.

Depending on the nature of the services provided, such information may be of little use. In many cases, for example, a number of service providers carve up a larger region into a number of service regions, with each provider being responsible for serving consumers located in only one service region and agreeing not to deal with consumers in other service regions. This may be done by agreement between the service providers, directly or indirectly such as with a franchise operation, or the service regions may be otherwise dictated, such as by statute, regulation or other rules imposed, or licenses granted, by state actors. In addition, when services are provided to consumers in their homes, practical limitations to service regions will exist due to geographic availability of workers to travel to such homes.

In all such cases, it is by no means true that the office or store location of the closest service provider to a consumer is the correct or most relevant service provider who is authorized (by contract or otherwise) to provide the subject service to that consumer.

One example where this is common is in the provision of home health care and community support services. One organization may deliver several services such as in-home nursing and “meals on wheels”. The organization's service region for each service will often differ based on state funding agreements; yet there is only one office location. A resident looking for service may, for example, be within the organization's service region for one, both or neither service, yet could be living very close to the main office location listed on typical web based search directories. This often leads to inaccurate search results.

A service provider wishing to specify its service region to potential consumers typically does so in narrative form. For example, the region for the organization might be indicated on the company website as serving “Centre Wellington and Mapleton”. The searching consumer may not readily know whether the address for which they are searching for is located in either area. For example, it may be very difficult to determine that the Town of Fergus is located in Centre Wellington, and not Mapleton.

State funding for service such as education, health and social services often follows current municipal boundaries. Municipal boundaries may change over time, yet service boundaries remain associated with what are now legacy municipal boundaries. For example, the City of Toronto, Canada is the amalgamation of six smaller former boroughs or cities (Scarborough, N.Y., etc.) that no longer exist as municipalities. Many public services funded from provincial ministries maintain service regions based on the previous six municipal boundaries. This complicates the consumer's process of correctly identifying a relevant service provider.

The above examples lead to wasted effort by consumers searching for services that can assist them, and wasted time by service providers fielding calls from consumers who are not in their service region.

### SUMMARY OF THE INVENTION

The invention provides a region building system for specifying service regions based on a plurality of predefined service areas, the system comprising a computer having a processor and a memory, and computer executable program code stored in the memory for running on the processor, wherein the program code comprises a service region specification module to:
a. receive a specification from a service provider of a type of service provided by the service provider;
b. receive a selection from the service provider of a service area to be a service region;
c. present to the service provider at least one other service area that is near the service region and receive from the service provider either (1) a selection of a presented service area to be included in the service region or (2) an indication that no more service areas are to be added to the service region; and
d. if the service provider selects a service area to be included in the service region, add the selected service area to the service region,
   wherein steps c and d are repeated until the code receives an indication from the service provider that no more service areas are to be added to the service region and wherein the service region is stored in the memory so that a consumer can search to determine if the consumer is in the service region.

The presented service areas may be adjacent to the service region.

The system may also comprise a service provider identification module to:
a. receive from a consumer a specification of a type of service desired and a desired service delivery location; and
b. identify to the consumer a service provider for the specified type of service such that the desired service delivery location is within the service region specified by the service provider.

A service area may be near a service region if at least one point in the service area is no more than 100 kilometres from at least one point in the service region, or if at least one point in the service area is no more than 10 kilometres from at least one point in the service region.

The system may display the service region to the service provider as a highlighted portion of a map on a computer screen.

The computer may be a server connected to a communications network and the server may receive input via the communications network from service providers and consumers who are using client computers. The communications network may be the internet, the server may be a web server, and the service providers and consumers may access the system using a web browser running on client computers.

The service region may be defined by a plurality of boundary points connected by lines and the service region specification module may receive instructions from the service provider to modify the location of a boundary point. The service provider may be able to modify the location of a boundary point by selecting it with a mouse and dragging it.

The system may alert the service provider if the service region specified by the service provider overlaps any service region specified by another service provider for the same type of service.

The system may allow the service provider to select a service area that has been added to the service region to indicate that the service area should be removed from the service region, and the system may then remove the service area from the service region.

The service provider may be able to select a service area to be a service region where the service area has been previously specified by any service provider.

### BRIEF DESCRIPTION OF THE DRAWINGS

FIG. 1 is a block diagram showing a region building system communicating with service providers and consumers over a communication network, and the associated major data flows.

FIG. 2 is a depiction of part of a display on a service provider client computer showing the current service region and two candidate additional service areas.

### DETAILED DESCRIPTION

The invention is a computer-based system that interacts with service providers and consumers. Generally the system is a server, connected to a communications network. The system generally includes at least one physical server having at least one programmable processor, a non-volatile memory accessible by the processor(s), and software, or program code, stored in the memory that is read and executed, or run, by the processor to implement certain functions on that physical server. The complete system, or server, may include a plurality of physical servers, interconnected so that they may share data. Multiple physical servers may execute the same functions, so that, for example, requests from different service providers and consumers may be handled by different servers, or they may be divided functionally. For example, one set of physical servers may run code implementing a service region specification module and deal with service providers, and another set of physical servers may run a service provider identification module and deal with consumers, with data such as service regions and other service provider information being shared between the two classes of physical servers. A module is a subset of the software that performs a specific set of functions. In general, the processor is defined to include all software or firmware required to execute the program code, such as operating system software and an interpreter for program code written in an interpreted language.

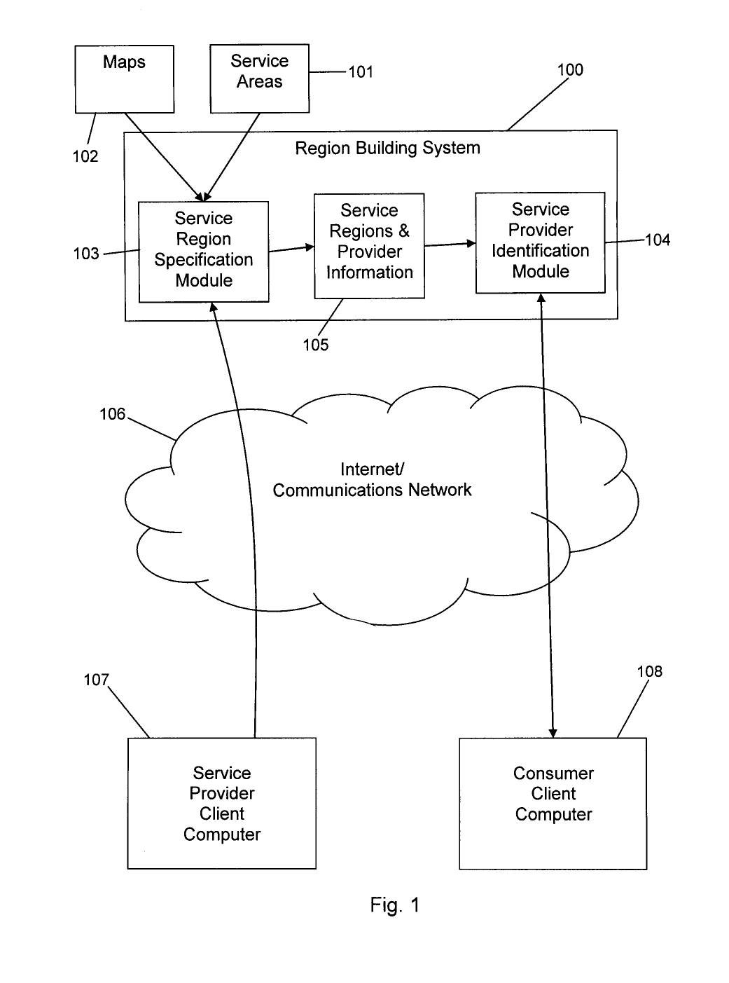

A preferred embodiment of the region building system 100 is depicted in FIG. 1. The region building system 100 includes two main software modules: the service region specification module 103, and the service provider identification module 104. In this preferred embodiment, the region building system 100 is a server running these two modules and interacting with service providers using service provider client computers 107, and with consumers using consumer client computers 108, over a communications network 106, such as the internet. The region building system 100 may provide a user interface over the communications network 106 with the system acting as a web server so that the service providers and consumers can interact with the region building system 100 using standard web browsers on their client computers 107, 108.

A service provider accessing the server may be presented with a page that offers the service provider the option to define a service. After choosing that option, the service region specification module 103 may then request a specification from the service provider of the type of service to be provided. This may be done by presenting a list of services from which the service provider may select at least one. The service region specification module 103 may then provide an interface to the service provider so that the service region specification module 103 may receive a specification from the service provider of a service region in which the service provider intends to provide the specified type of service. The specification of the service type and service region is typically done online via the communication network with the service provider or agent of the service provider interacting with the service region specification module 103 directly, although other approaches to provide this data to the service region specification module 103 are possible. A service provider could send a request by email, for example, and attach a map showing the service region, to the website operator who could then provide the information to the service region specification module 103 required to generate the service region.

A service area 101 is a set of geographical locations. Such a set may be specified or described by a closed curve or polygon overlaid on a map defining the boundary of the service area so that the service area includes all the points on the map inside the curve. Such a boundary may be defined by at least three boundary points connected by lines. Each boundary point may be stored as a latitude and longitude to a desired level of accuracy, which is generally chosen to be sufficient to define a boundary down the middle of a road. For example, the locations of the boundary points may be accurate to within three metres. Generally the lines connecting the boundary points are straight, although in some embodiments a smoothing algorithm may be employed.

The region building system 100 employs a database of predefined service areas 101. Such service areas 101 may be defined in many ways. For example, a large area, such as a state or province, may be divided into a plurality of non-overlapping service areas 101 so that every location in the state or province is in one, and only one, service area 101. This could be done, for example, based on postal or zip codes, natural boundaries, such as rivers and lakes, or county and municipality boundaries. The service area database may include multiple such sets of service areas 101, having differing granularity. These may depend on the type of service, but will normally include, at a minimum, all current geopolitical boundaries, including upper and lower tier municipalities, education, health and social service regions. It may also include recent former geopolitical boundaries, for example if any boundaries have changed in the last 20 years, because some service providers may still be constrained by such former boundaries.

The region building system 100 employs a database of maps 102, such as might be provided, for example, by Google Maps™. When a service provider indicates that he or she wishes to specify a service region, such as by having specified to the service region specification module 103 a type of service to be provided, the service region specification module 103 may then display a map 102 to the service provider. The initial map displayed may, for example, be based on the service provider's IP address and show a map of the country in which the service provider's ISP is located. The service provider may be able to click on a point on the map to zoom in.

Alternatively, or subsequently, the service region specification module 103 may request that the service provider enter an address, which could be a street address or a region, such as the name of a city or county. This may be the location of the service provider's facility. The service region specification module 103 may then display a map including the specified address or region. For example, if a street address is specified, the service region specification module 103 may display a map of the city the address is in, optionally with a marker indicating where the address is within the displayed map.

The service region specification module 103 may then search the service area database to identify which service areas 101 include the specified address or region within its area. The service region specification module 103 may select a service area from a list of several as a candidate initial service region and highlight that service area 101 on the displayed map, e.g. by drawing a solid line depicting the boundary and shading the interior. The candidate initial service region may be selected by the service region specification module 103 based on the type of service. For example, for a home health care service, the service area database may include known home health care service areas 101, and the candidate initial service region may then be chosen to be the home health care service area 101 containing the specified address. The service region specification module 103 may then give the service provider the option to select the displayed service area 101 to be the initial service region, for example by clicking a button. It may also provide a list of alternative service areas 101 that the service provider can click on in order to view them. These may include service areas of a different granularity, such as the containing city and zip or postal code area. After the service provider has selected one service area 101, that service area 101 becomes the initial service region.

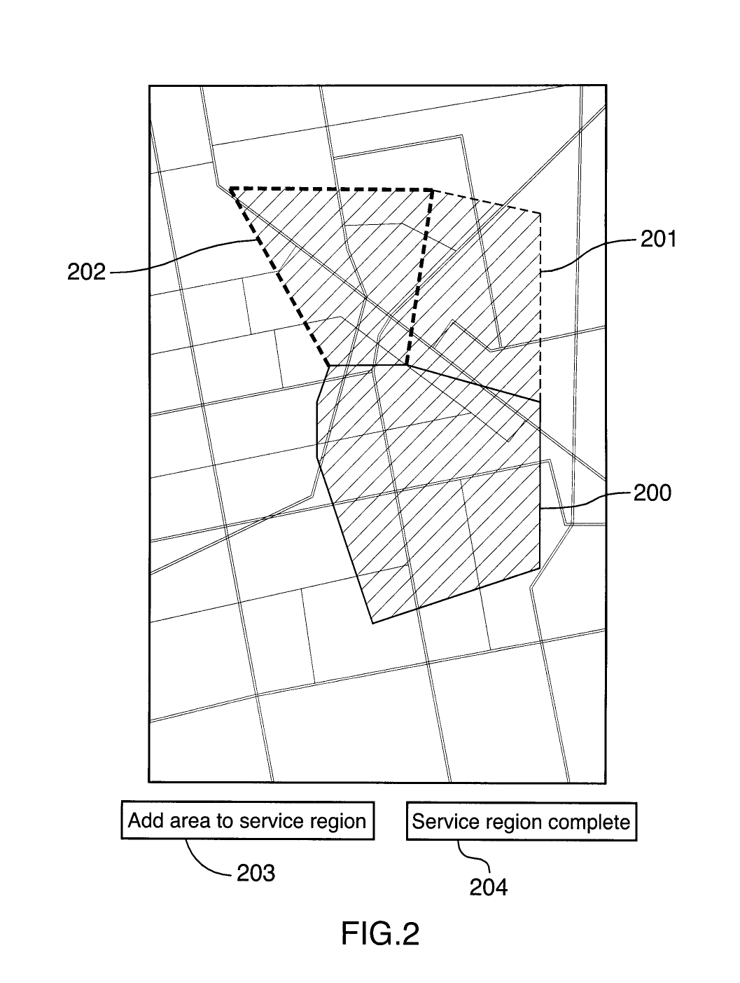

The current service region 200 may be displayed on a map as shown in FIG. 2 for example, using a solid boundary overlaying a map with the interior being shaded. The service region specification module 103 may also then display at least one other service area 201, 202 that is near the service region 200. The other service areas may be selected by the service region specification module 103, for example, based on which service areas 101 in the service area database are adjacent to the current service region 200. In FIG. 2, two service areas 202, 203 adjacent to the current service region 200 are depicted with dashed lines as boundaries. Alternatively, the service region specification module 103 may display or list all service areas 101 that are less than a certain distance from the current service area, such as within 100 kilometres, 50 kilometres, 10 kilometres, or 5 kilometres, or it may display or list all the closest such service areas 101 up to some predefined maximum number of service areas 101. The distance between a service area 101 and the service region 200 is the minimum distance between any point in the service area 101 and any point in the service region 200.

The service region specification module 103 normally displays candidate service areas 101 that are of the same granularity as the service areas that have previously been selected by the service provider to be part of the service region 200. However, service areas 101 of a different granularity, which may overlap or enclose the current service region 200, may also be presented as alternatives, such as in a list on one side of the display.

After the service provider has clicked on another service area 101, the service region specification module 103 may present and highlight that service area 202 on the display, for example by modifying the highlighting used to show the service area 202 on the underlying map. The service provider may then click a button, such as the “add area to service region” button 203 shown in FIG. 2 to select the presented service area to be included in the service region. Then the service region is modified by the service region specification module 103 to include the selected service area 202. This process is repeated until the service provider indicates that no more service areas 101 are to be added to the service region. This may be done, for example, by clicking on a “service region complete” button 204.

Like a service area, the service region is also generally defined by a plurality of boundary points connected by lines. When a service area 101 is added to a service region, the boundary points of the service region are modified to include the additional service area 101. This may involve deleting boundary points from the service region where the additional service area 101 is adjacent to or overlaps the current service region. The additional service area 101 and current service region may be disjoint, in which case the new boundary includes all boundary points of both the additional service area 101 and current service region.

The service region specification module 103 may be able to receive instructions from the service provider to modify the location of boundary points. This may be done, for example, by highlighting all the boundary points on a map displayed to the service provider and then allowing the service provider to drag individual points to new locations using a mouse, with the lines forming the boundary connected to those points being resized and moved as necessary.

Candidate additional service areas are generally selected based on their proximity to the current service area, but may also be chosen in other ways. For example, the service region specification module 103 may allow the service provider to enter another address, or otherwise specify another area, and the service region specification module 103 may then present additional candidate service areas 101 near the specified address or region.

The service region specification module 103 may also alert the service provider if the service region specified by the service provider overlaps any service region specified by another service provider for the same type of service. This may indicate an error in the specification of the service region and allow the service provider to correct the error.

The service region specification module 103 may also allow service providers to search and view service regions previously specified by other service providers and give a service provider the option of treating such a service region as a service area 101 that it may select as its initial service region.

The service region specification module 103 may also allow the service provider to remove service areas 101 that were previously added to the service region. This may be done, for example, by the service provider clicking on a point in the service region to select it and the service region specification module 103 then highlighting that service area 101 within the service region. The service provider may then click on a button, for example named “remove service area”, to instruct the service region specification module 103 to remove the service area 101 from the service region.

When the service region has been fully specified, the service region specification module 103 may then store the service region in a service regions and provider information database 105. In addition to the defined service region and type of service, other information may be obtained from the service provider and stored in the database 105, such as the service provider's name, the location of the service provider, and details about the nature and availability of the services. In this manner the region building system 100 may accumulate a substantial database of service provider information.

The region building system 100 also includes a service provider identification module 104 that provides an interface to consumers to search for service providers. The service provider identification module 104 provides an interface to allow the consumer to specify a type of service desired and a desired service delivery location. This may be done, for example, by selecting a type of service from a list, and by entering an address. The address may be, for example, a street address or a specification of an area that includes the consumer's location, such as a zip or postal code. The service provider identification module 104 may then search the service provider information database 105 to identify which, if any, service providers service the consumer's location. If a street address is specified by the consumer, the search can be done by simply checking whether that address is within the service region of each provider of the specified type of service in the database 105. If a region is specified, the service provider identification module 104 may then determine whether the specified region is fully within, or partly within, the service region of any providers. A list of such service providers may then be presented to the consumer.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

1. A region building system for specifying service regions based on a plurality of predefined service areas, the system comprising a computer having a processor and a memory, and computer executable program code stored in the memory for running on the processor, wherein the program code comprises a service region specification module to:
a. receive a specification from a service provider of a type of service provided by the service provider;
b. receive a selection from the service provider of a first service area to be a service region;
c. present to the service provider at least one other service area that is near the service region and receive from the service provider a selection of a presented service area to be included in the service region; and
d. add the additional selected service area to the service region,
wherein steps c and d until the code receives an indication from the service provider that no more service areas are to be added to the service region and wherein the service region is stored in the memory so that a consumer can search to determine if the consumer is in the service region.

2. The system of claim 1 further comprising a service provider identification module to:
a. receive from a consumer a specification of a type of service desired and a desired service delivery location; and
b. identify to the consumer a service provider for the specified type of service such that the desired service delivery location is within the service region specified by the service provider.

3. The system of claim 1 wherein a service area is near a service region if at least one point in the service area is no more than 100 kilometres from at least one point in the service region.

4. The system of claim 3 wherein a service area is near a service region if at least one point in the service area is no more than 10 kilometres from at least one point in the service region.

5. The system of claim 1 wherein the system displays the service region to the service provider as a highlighted portion of a map on a computer screen.

6. The system of claim 2 wherein the computer is a server connected to a communications network and the server receives input via the communications network from service providers and consumers who are using client computers.

7. The system of claim 6 wherein the communications network is the internet, the server is a web server, and the service providers and consumers access the system using a web browser running on client computers.

8. The system of claim 1 wherein the service region is defined by a plurality of boundary points connected by lines and the service region specification module can receive instructions from the service provider to modify the location of a boundary point.

9. The system of claim 8 wherein the service provider can modify the location of a boundary point by selecting it with a mouse and dragging it.

10. The system of claim 1 wherein the system alerts the service provider if the service region specified by the service provider overlaps any service region specified by another service provider for the same type of service.

11. The system of claim 1 wherein the presented service areas are adjacent to the service region.

12. The system of claim 1 wherein the system allows the service provider to select a service area that has been added to the service region to indicate that the service area should be removed from the service region, and the system then removes the service area from the service region.

13. The system of claim 1 wherein the service provider may select a service area to be a service region where the service area has been previously specified by a service provider.
